(19) United States
(12) Patent Application Publication
(10) Pub. No.: US 2002/0136465 A1
(43) Pub. Date: Sep. 26, 2002

(54) Method and apparatus for image interpolation

(76) Inventor: Hiroki Nagashima, Tokyo (JP)

Correspondence Address: Dowell & Dowell, P.C., Suite 309, 1215 Jefferson Davis Highway, Arlington, VA, 22202, US

(21) Appl. No.: 10/017,388

(22) Filed: Dec. 18, 2001

(30) Foreign Application Priority Data
Dec. 26, 2000 (JP) 2000-395777
May 22, 2001 (JP) 2001-152243

(51) Int. Cl. G06K 9/36

(52) U.S. Cl. 382/276

(57) ABSTRACT

A key frame memory stores key frames which were obtained by photographing a product from various viewpoints in vertical and horizontal directions, preferably at predetermined angular intervals. An intermediate frame position acquiring unit acquires a position of an intermediate frame to be generated, for example from user input, in relation to the key frames. A matching processor computes a matching between the key frames adjacent to the intermediate frame. An intermediate frame generator generates the intermediate frame using interpolation based on the matching results.

### BACKGROUND OF THE INVENTION

1. Field of the Invention

The present invention relates to image interpolation techniques, and more particularly relates to a method and apparatus for image interpolation and for image processing.

2. Description of the Related Art

With the increased use of the Internet, more and more businesses, which started out using the Internet as a means for supplying information, are using the Internet to allow online shopping. Recently, major enterprises, which already have powerful sales networks, are launching into direct sales using the Internet. It is clear that traditional forms of trading structures and commercial dealings, which have been built up over centuries, have come to a turning point.

Many enterprises welcome this trend of “restructuring” of trade structures because the new structures allow more efficient management through reduced intermediary cost and the possibilities for inventory-less and store-less operation. Users, on the other hand, support these new structures for the convenience of access to a large volume of product information and the possibility to obtain desired products while staying at home.

Considering the ever-increasing use of PCs (personal computers) and other electronic devices and the beneficial characteristics of online shopping to both product suppliers and consumers, it is clear that online shopping will continue to expand in the future.

One problem for a user of online shopping is that the user would often prefer a closer look at the product as if it were in the user's hands or as if the user could see all sides of the product. In fact, according to one survey, sales jump several-fold when a pseudo three-dimensional (3D) image, in which a product is rotated in the display, is used instead of a static two-dimensional image. However, a pseudo 3D type of display requires a great amount of preparation on the part of the network site presenting the product. For example, there is a known technique, for preparing a rotating display of a product, which involves taking approximately 360 photos at about one-degree intervals all around the product and then switching these images according to the viewpoint that the user wants to see to ensure relative smoothness of the 3D image.

Aside from the work required for preparation, it is also quite troublesome to transmit a large number of photos or images to the user terminal to allow smooth rotation. In particular, the amount of data required to be sent for this purpose may be several megabytes or much higher. Since much of this data must be downloaded each time the user tries to view the product, users will quickly tire of waiting and may complain of such delays.

### SUMMARY OF THE INVENTION

The present invention has been made in view of the foregoing circumstances and an object thereof is to provide an image interpolation and processing technology for pseudo three-dimensional display of a product or any other arbitrary object in high image quality using a reduced amount of data.

The embodiments of the present invention, which relate to an image interpolation or processing technology, are not necessarily intended for commercial goods only. For example, they can also be applied to image interpolation in movies and so forth and compression effects of motion pictures which are also within the scope of the present invention.

An embodiment of the present invention relates to an image interpolation method. This method includes: (1) acquiring a first image pair, comprising two key frames, and first corresponding point data between the two key frames; (2) acquiring a second image pair, comprising two key frames, and second corresponding point data between the two key frames; and (3) generating an intermediate frame by interpolation, wherein the interpolation utilizes positional relations of a first axis and a second axis, the first corresponding point data and the second corresponding point data, wherein the first axis is determined temporally or spatially between the two key frames of the first image pair, and the second axis is determined temporally or spatially between the two key frames of the second image pair.

In the above (1) and (2), both the first corresponding point data and the second corresponding point data may be obtained by a matching between the key frames. In the above (3), a bilinear interpolation may be performed using the first axis and the second axis. As an example, key frames obtained from two viewpoints that are p1(0,0) and p2(0,100) serve as the first image pair while key frames obtained from another two viewpoints that are p3(100,0) and p4(100,100) as the second image pair. A straight line connecting points p1 and p2 may correspond to the first axis while a straight line connecting points p3 and p4 may correspond to the second axis.

In a case where an image, which serves as an intermediate frame, viewed from a viewpoint p′=(50,50) is to be obtained, a frame from a viewpoint (0,50) is first generated based on the corresponding point data between the first image pair. Next, another frame from a viewpoint (100,50) is generated based on corresponding point data between the second image pair. Thereafter, an interpolation is performed on these two frames, namely, they are interior-divided at a ratio of 1:1, so that a desired intermediate frame is generated. Here, in order to perform an interpolation in both the vertical and horizontal directions, it is generally preferable that the first image pair and the second image pair are determined so that the first axis and the second axis do not lie on a same line.

Although in the above example the first axis and the second axis are spatially determined respectively between the two key frames, there is another example in which the first axis and the second axis are determined temporally. For example, if it is supposed that two key frames obtained from a viewpoint P at time t=t0 and t=t1 serve as the first image pair while two key frames obtained from another viewpoint Q at time t=t0 and t=t1 serve as the second image pair. In this case, a straight line connecting a point defined by (P, t0) and a point defined by (P, t1) in relation to the fist image pair becomes the first axis, and similarly a straight line connecting a point defined by (Q, t0) and a point defined by (Q, t1) in relation to the second image pair becomes the second axis. Thus, if it is supposed that an image from, for example, a point ((P+Q)/2, (t0+t1)/2) is regarded as a desired intermediate frame, it is preferable that after intermediate- like images are generated for the respective two axes, the intermediate-like images are interpolated. Hereinafter, time and space are treated as mere parameters in four dimensions, and are not generally considered distinct from each other in any particular manner.

One of the two key frames in the first image pair and one of the two key frames in the second image pair may be put to a common use, and the interpolation may be performed based on a triangle having the first axis and the second axis as two sides thereof. Alternatively, the first image pair and the second image pair may not have any key frames in common, and the interpolation may be performed based on a quadrilateral having the first axis and the second axis as two sides opposite to each other.

The method may further include: acquiring a positional relation between the intermediate frame, the two key frames of the first image pair and the two key frames of the second image pair, so that the interpolation may be performed based on said positional relation. This process relates to the first example where the viewpoint position of the intermediate frame is determined as, for example (50, 50), based on a user's intention.

The first and second corresponding point data may be detected or determined based on a matching that is computed pixel-by-pixel based on correspondence between critical points detected through respective two-dimensional searches on the two key frames.

Moreover, the detecting process may include: multiresolutionalizing the two key frames by respectively extracting the critical points; performing a pixel-by-pixel matching computation on the two key frames, at same resolution levels; and acquiring a pixel-by-pixel correspondence relation at a finest level of resolution while inheriting a result of a pixel-by-pixel matching computation in a different resolution level.

Another embodiment of the present invention relates to an image interpolation apparatus that includes: a unit which stores a plurality of key frames; a unit which acquires temporal or spatial position data on an intermediate frame, in relation to the key frames; and an intermediate frame generator which generates an intermediate frame by an interpolation processing, based on corresponding point data on a first image pair comprised of two key frames and a second image pair comprised of two key frames, and the position data, wherein the first image pair and the second image pair are determined so that a first axis determined temporally or spatially between the two key frames of the first image pair and a second axis determined temporally or spatially between the two key frames of the second image pair do not lie on a same line. This apparatus may further include a matching processor which generates the corresponding point data.

The matching method using the critical points is an application of the technology (hereinafter referred to as “base technology”) proposed in Japanese Patent No. 2927350 owned by the same assignee of the present patent application, and is suited for the above-described detecting process. However, the base technology does not describe the feature of interpolation performed along the vertical and horizontal directions. By implementing a new technique according to the embodiments of the present invention, images of merchandise or so forth viewed from various angles or viewpoints can be generated, while using only a small amount of data, which can be suitable for electronic commerce (EC) or the like.

Still another embodiment of the present invention relates to an image processing method. In this method, a plurality of corresponding point files which describe corresponding point data between the key frames are prepared or acquired, and a mixing processing is performed on these so as to generate a new corresponding point file. The “mixing processing” may be, for example, bilinear interpolation. In order to acquire the corresponding point file, a matching processor such as that described below may be utilized.

This method may further include a processing in which an intermediate frame between the key frames is generated, by interpolation, based on the thus generated new corresponding point file.

It is to be noted that the base technology is not a prerequisite in the present invention. Moreover, it is also possible to have replacement or substitution of the above- described structural components and elements of methods in part or whole as between method and apparatus or to add elements to either method or apparatus. Also, the apparatuses and methods may be implemented by a computer program and saved on a recording medium or the like and are all effective as and encompassed by the present invention.

Moreover, this summary of the invention includes features that may not be necessary features such that an embodiment of the present invention may also be a sub-combination of these described features.

### BRIEF DESCRIPTION OF THE DRAWINGS

FIG. 1(a) is an image obtained as a result of the application of an averaging filter to a human facial image.

FIG. 1(b) is an image obtained as a result of the application of an averaging filter to another human facial image.

FIG. 1(c) is an image of a human face at p^{(5,0)} obtained in a preferred embodiment in the base technology.

FIG. 1(d) is another image of a human face at p^{(5,0)} obtained in a preferred embodiment in the base technology.

FIG. 1(e) is an image of a human face at p^{(5,1)} obtained in a preferred embodiment in the base technology.

FIG. 1(f) is another image of a human face at p^{(5,1)} obtained in a preferred embodiment in the base technology.

FIG. 1(g) is an image of a human face at p^{(5,2)} obtained in a preferred embodiment in the base technology.

FIG. 1(h) is another image of a human face at p^{(5,2)} obtained in a preferred embodiment in the base technology.

FIG. 1(i) is an image of a human face at p^{(5,3)} obtained in a preferred embodiment in the base technology.

FIG. 1(j) is another image of a human face at p^{(5,3)} obtained in a preferred embodiment in the base technology.

FIG. 2(R) shows an original quadrilateral.

FIG. 2(A) shows an inherited quadrilateral.

FIG. 2(B) shows an inherited quadrilateral.

FIG. 2(C) shows an inherited quadrilateral.

FIG. 2(D) shows an inherited quadrilateral.

FIG. 2(E) shows an inherited quadrilateral.

FIG. 3 is a diagram showing the relationship between a source image and a destination image and that between the m-th level and the (m−1)th level, using a quadrilateral.

FIG. 4 shows the relationship between a parameter η (represented by x-axis) and energy C_{f} (represented by y-axis)

FIG. 5(a) is a diagram illustrating determination of whether or not the mapping for a certain point satisfies the bijectivity condition through the outer product computation.

FIG. 5(b) is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source hierarchical images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 12.

FIG. 16 is a graph showing the behavior of energy C_{f}^{(m,s)} corresponding to f^{(m,s)} (λ=iΔλ) which has been obtained for a certain f^{(m,s)} while varying λ.

FIG. 17 is a diagram showing the behavior of energy C_{f}⁽ⁿ⁾ corresponding to f⁽ⁿ⁾(η=iΔη) (i=0, 1, . . . ) which has been obtained while varying η.

FIGS. 18A, 18B, 18C and 18D illustrate key frames of a coffee cup photographed from different angles.

FIG. 18E illustrates an intermediate frame generated from the four key frames shown in FIGS. 18A, 18B, 18C and 18D.

FIG. 19 shows an image interpolation apparatus according to an embodiment of the invention.

FIG. 20 conceptually illustrates a positional relation between an intermediate frame to be generated and key frames on which the intermediate frame is based.

FIG. 21 conceptually illustrates a method of interpolation processing performed by the image interpolation apparatus.

FIG. 22 is a flowchart showing a processing procedure used by the image interpolation apparatus.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

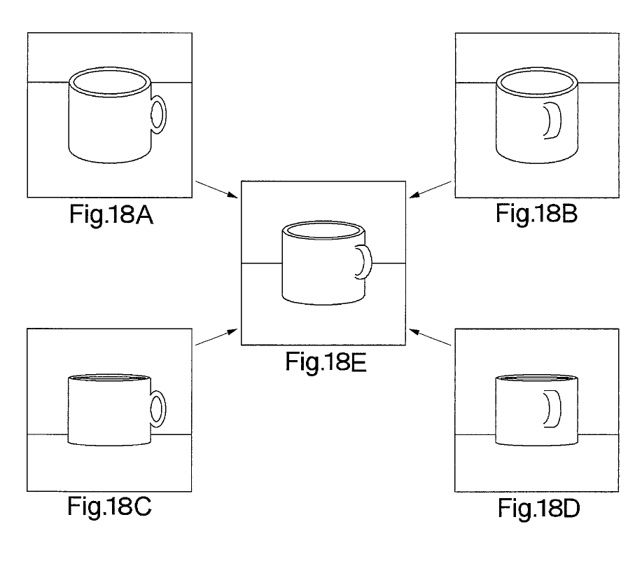

First, the multiresolutional critical point filter technology and the image matching processing using the technology, both of which will be utilized in the preferred embodiments, will be described in detail as “Base Technology”. Namely, the following sections [1] and [2] (below) belong to the base technology, where section [1] describes elemental techniques and section [2] describes a processing procedure. These techniques are patented under Japanese Patent No. 2927350 and owned by the same assignee of the present invention. However, it is to be noted that the image matching techniques provided in the present embodiments are not limited to the same levels. In particular, in FIGS. 18 to 22, image interpolation and image processing techniques and apparatus representing embodiments of the present invention utilizing, in part, the base technology will be described in more detail.

Base Technology

[1] Detailed Description of Elemental Techniques

[1.1] Introduction

Using a set of new multiresolutional filters called critical point filters, image matching is accurately computed. There is no need for any prior knowledge concerning the content of the images or objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, and smooth generation of motion images from a small number of frames. When applied to morphing, given images can be automatically transformed. When applied to volume rendering, intermediate images between cross sections can be accurately reconstructed, even when a distance between cross sections is rather large and the cross sections vary widely in shape.

[1.2] The Hierarchy of the Critical Point Filters

The multiresolutional filters according to the base technology preserve the intensity and location of each critical point included in the images while reducing the resolution. Initially, let the width of an image to be examined be N and the height of the image be M. For simplicity, assume that N=M=2n where n is a positive integer. An interval [0, N] c R is denoted by I. A pixel of the image at position (i, j) is denoted by p^{(i,j)} where i, jεI.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m} (0≦m≦n) . A critical point filter constructs the following four new hierarchical images recursively, in the direction descending from n.

p_{(i,j)}^{(m,0)}=min(min(p_{(2i,2j)}^{(m+1,0)}, p_{(2i, 2j+1)}^{(m+1,0)}, min(p_{(2i+1,2j)}^{(m+1,0)}, p_{(2i+1, 2j+1)}^{(m+1,0)}))

p_{(i,j)}^{(m,1)}=max(min(p_{(2i,2j)}^{(m+1,1)}, p_{(2i, 2j+1)}^{(m+1,1)}), min(p_{(2i+1,2j)}^{(m+1,1)}, p_{(2i+1, 2j+1)}^{(m+1,1)}))

p_{(i,j)}^{(m,2)}=min(max(p_{(2i,2j)}^{(m+1,2)}, p_{(2i, 2j+1)}^{(m+1,2)}), max(p_{(2i+1,2j)}^{(m+1,2)}, p_{(2i+1,2j+1)}^{(m+1,2)}))

p_{(i,j)}^{(m,3)}=max(max(p_{(2i,2j)}^{(m+1,3)}, p_{(2i, 2j+1)}^{(m+1,3)}, max(p_{(2i+1,2j)}^{(m+1,3)}, p_{(2i+1, 2j+1)}^{(m+1,3)})) (1)

where we let

p_{(i,j)}^{(n,0)}=p_{(i,j)}^{(n,1)}=p_{(i,j)}^{(n,2)}=p_{(i,j)}^{(n,3)}=p_{(i,j)} (2)

The above four images are referred to as subimages hereinafter. When min_{x≦t≦x+1} and max_{x≦t≦x+1} are abbreviated to a and β, respectively, the subimages can be expressed as follows:

p^{(m,0)}=α(x)α(y)p^{(m+1,0)}

p^{(m,1)}=α(x)β(y)p^{(m+1,1)}

p^{(m,2)}=β(x)α(y)p^{(m+1,2)}

p^{(m,2)}=β(x)β(y)p^{(m+1,3)}

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (1 pixel here) of a critical point detected inside each of the respective blocks serves to represent its block image (4 pixels here) in the next lower resolution level. Thus, the resolution of the image is reduced. From a singularity theoretical point of view, α(x)α(y) preserves the local minimum point (minima point) , β(x)β(y) preserves the local maximum point (maxima point), α(x)β(y) and β(x)α(y) preserve the saddle points.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of resolution levels. First, the minima points are matched using p^{(m,0)}. Next, the first saddle points are matched using p^{(m,1)} based on the previous matching result for the minima points. The second saddle points are matched using p^{(m,2)}. Finally, the maxima points are matched using p^{(m,3)}.

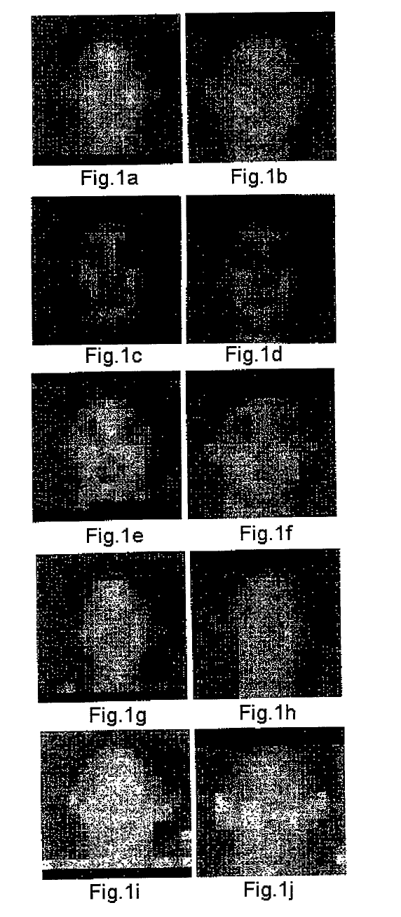

FIGS. 1c and 1d show the subimages p^{(5,0)} of the images in FIGS. 1a and 1b, respectively. Similarly, FIGS. 1e and 1f show the subimages p^{(5,1)}, FIGS. 1g and 1h show the subimages p^{(5,2)}, and FIGS. 1i and 1j show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1)} since the mouths have low intensity in the horizontal direction. Vertical lines on both sides of the necks become clear by p^{(5,2)}. The ears and bright parts of the cheeks become clear by p^{(5,3)} since these are the maxima points of pixel intensity.

As described above, the characteristics of an image can be extracted by the critical point filter. Thus, by comparing, for example, the characteristics of an image shot by a camera with the characteristics of several objects recorded in advance, an object shot by the camera can be identified.

[1.3] Computation of Mapping Between Images

Now, for matching images, a pixel of the source image at the location (i,j) is denoted by p_{(i,j)}⁽ⁿ⁾ and that of the destination image at (k,l) is denoted by q_{(k,l)}⁽ⁿ⁾ where i, j, k, l εI. The energy of the mapping between the images (described later in more detail) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)} and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0, 1, 2, . . . ) is referred to as a submapping. The order of i will be rearranged as shown in the following equation (3) in computing f^{(m,i)} for reasons to be described later.

f^{(m,i)}: p^{(m,σ(i))→q}^{(m,σ(i))} (3)

where σ(i)ε{0, 1, 2, 3}.

[1. 3. 1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be noted that the mappings to be constructed here are the digital version of the bijection. In the base technology, a pixel is specified by a co-ordinate point.

The mapping of the source subimage (a subimage of a source image) to the destination subimage (a subimage of a destination image) is represented by f^{(m,s)}: I/2^{n-m}X I/2^{n-m}→I/2^{n-m}X I/2^{n-m} (s=0, 1, . . . ), where f_{(i,j)}^{(m,s)}=(k,l) means that p_{(i,j)}^{(m,s)} of the source image is mapped to q_{(k,l)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bijection will be defined in the following manner, where i, j, k and l are all integers. First, a square region R defined on the source image plane is considered

p_{(i,j)}^{(m,s)}p_{(i+1,j)}^{(m,s)}p_{(i+1,i+1)}^{(m,s)}p_{(i,j+1)}^{(m,s)} (4)

where i=0, . . . , 2^{m}−1, and j=0, . . . , 2^{m}−1. The edges of R are directed as follows:

$$\vec{{p}_{( i , j )}^{( m , s )} {p}_{( i + 1 , j )}^{( m , s )}} , \vec{{p}_{( i + 1 , j )}^{( m , s )} {p}_{( i + 1 , j + 1 )}^{( m , s )}} , \vec{{p}_{( i + 1 , j + 1 )}^{( m , s )} {p}_{( i , j + 1 )}^{( m , s )}} and \vec{{p}_{( i , j + 1 )}^{( m , s )} {p}_{( i , j )}^{( m , s )}} . \qquad ( 5 )$$

This square region R will be mapped by f to a quadrilateral on the destination image plane:

q_{f(i,j)}^{(m,s)}q_{f(i+1,j)}^{(m,s)}q_{f(i+1,j+1)}^{(m,s)}q_{f(i,j+1)}^{(m,s)} (6)

This mapping f^{(m,s)}(R), that is,

f^{(m,s)}(R)=f^{(m,s)}(p_{(i,j)}^{(m,s)}p_{(i+1,j)}^{(m,s)}p_{(i+1,j+1)}^{(m,s)}p_{(i,j+1)}^{(m,s)})=q_{f(i,j)}^{(m,s)}q_{f(i+1,j)}^{(m,s)}q_{f(i+1,j+1)}^{(m,s)}q_{f(i,j+1)}^{(m,s)})

should satisfy the following bijectivity conditions (referred to as BC hereinafter):

1. The edges of the quadrilateral f^{(m,s)}(R) should not intersect one another.

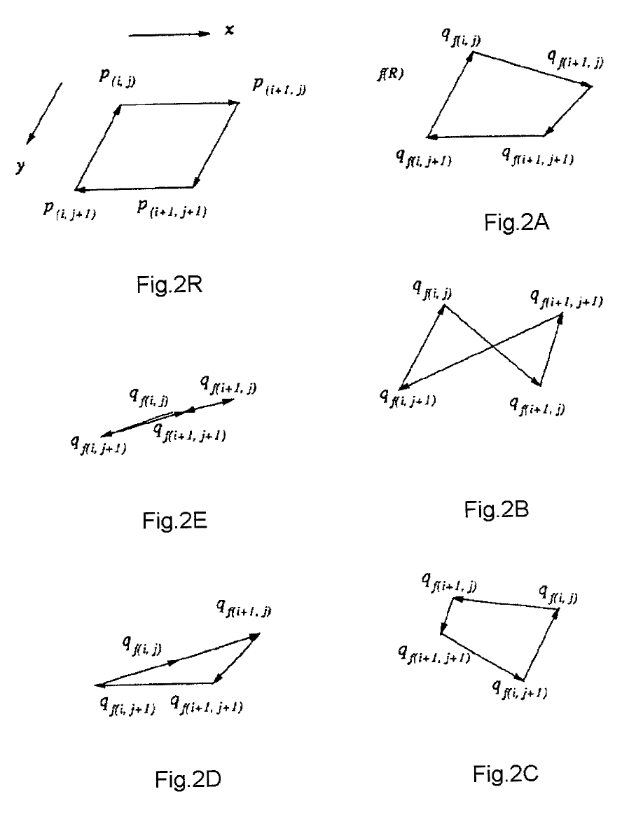

2. The orientation of the edges of f^{(m,s)}(R) should be the same as that of R (clockwise in the case shown in FIG. 2, described below).

3. As a relaxed condition, a retraction mapping is allowed.

Without a certain type of a relaxed condition as in, for example, condition 3 above, there would be no mappings which completely satisfy the BC other than a trivial identity mapping. Here, the length of a single edge of f^{(m,s)}(R) may be zero. Namely, f^{(m,s)}(R) may be a triangle. However, f^{(m,s)}(R) is not allowed to be a point or a line segment having area zero. Specifically speaking, if FIG. 2R is the original quadrilateral, FIGS. 2A and 2D satisfy the BC while FIGS. 2B, 2C and 2E do not satisfy the BC.

In actual implementation, the following condition may be further imposed to easily guarantee that the mapping is surjective. Namely, each pixel on the boundary of the source image is mapped to the pixel that occupies the same location at the destination image. In other words, f(i,j)=(i,j) (on the four lines of i=0, i=2^{m}−1, j=0, j=2^{m}−1). This condition will be hereinafter referred to as an additional condition.

[1. 3. 2] Energy of Mapping

[1. 3. 2. 1] Cost Related to the Pixel Intensity

The energy of the mapping f is defined. An objective here is to search a mapping whose energy becomes minimum. The energy is determined mainly by the difference in the intensity between the pixel of the source image and its corresponding pixel of the destination image. Namely, the energy C_{(i,j)}^{(m,s)} of the mapping f^{(m,s)} at (i,j) is determined by the following equation (7).

C_{(i,j)}^{(m,s)}=|V(p_{(i,j)}^{(m,s)}−V(q_{f(i,j)}^{(m,s)})|² (7)

where V(p_{(i,j)}^{(m,s)}) and V(q_{f(i,j)}^{(m,s)}) are the intensity values of the pixels p_{(i,j)}^{(m,s)} and q_{f(i,j)}^{(m,s)}, respectively. The total energy C^{(m,s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} . \qquad ( 8 )$$

[1.3.2.2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0, 1, . . . , 2^{m}−1, j=0, 1, . . . , 2^{m}−1), regardless of the intensity of the pixels. The energy D_{(i,j)}^{(m,s)} of the mapping f^{(m,s)} at a point (i,j) is determined by the following equation (9).

D_{(i,j)}^{(m,s)}=ηE_{0(i,j)}^{(m,s)}+E_{1(i,j)}^{(m,s)} (9)

where the coefficient parameter η which is equal to or greater than 0 is a real number. And we have

E_{0(i,j)}^{(m,s)}=||(i,j)−f^{(m,s)}(i,j)||² (10)

$${E}_{1 ( i , j )}^{( m , s )} = {\sum }_{{i}^{′} = i - 1}^{i} {\sum }_{{j}^{′} = j - 1}^{j} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 \qquad ( 11 )$$

where

||(x,y)||=\sqrt{x²+y²} (12)

i′ and j′ are integers and f(i′, j′) is defined to be zero for i′<0 and j′<0. E₀ is determined by the distance between (i,j) and f(i,j). E₀ prevents a pixel from being mapped to a pixel too far away from it. However, as explained below, E₀ can be replaced by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation:

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} . \qquad ( 13 )$$

[1.3.2.3] Total Energy of the Mapping

The total energy of the mapping, that is, a combined evaluation equation which relates to the combination of a plurality of evaluations, is defined as λC_{f}^{(m,s)}+D_{f}^{(m,s)}, where λ≧0 is a real number. The goal is to detect a state in which the combined evaluation equation has an extreme value, namely, to find a mapping which gives the minimum energy expressed by the following:

$${min}_{f} \{ λ {C}_{f}^{( m , s )} + {D}_{f}^{( m , s )} \} . \qquad ( 14 )$$

Care must be exercised in that the mapping becomes an identity mapping if λ=0 and η=0 (i.e., f^{(m,s)}(i,j)=(i,j) for all i=0, 1, . . . , 2^{m}−1 and j=0, 1, . . . , 2^{m}−1) . As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would randomly matched to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, differences in the pixel intensity and smoothness are considered in a technique called “optical flow” that is known in the art. However, the optical flow technique cannot be used for image transformation since the optical flow technique takes into account only the local movement of an object. However, global correspondence can also be detected by utilizing the critical point filter according to the base technology.

[1.3.3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, and where possible, mappings at other levels are considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint condition.

We thus define a parent and child relationship between resolution levels. When the following equation (15) holds,

$$( {i}^{′} , {j}^{′} ) = ( ⌊ \frac{i}{2} ⌋ , ⌊ \frac{j}{2} ⌋ ) , \qquad ( 15 )$$

where └x└ denotes the largest integer not exceeding x, p_{(i′,j′)}^{(m-1,s)} and q_{(i′,j′)}^{(m-1,x)} are respectively called the parents of p_{(i,j)}^{(m,s)} and q_{(i,j)}^{(m,s)},. Conversely, p_{(i,j)}^{(m,s)} and q_{(i,j)}^{(m,s)} are the child of p_{(i′,j′)}^{(m-1,s)} and the child of q_{(i′,j′)}^{(m-1,s)}, respectively. A function parent (i,j) is defined by the following equation (16):

$$parent ( i , j ) = ( ⌊ \frac{i}{2} ⌋ , ⌊ \frac{j}{2} ⌋ ) . \qquad ( 16 )$$

Now, a mapping between p_{(i,j)}^{(m,s)} and q_{(k,l)}^{(m,s)} is determined by computing the energy and finding the minimum thereof. The value of f^{(m,s)}(i,j)=(k,l) is determined as follows using f(m−1,s) (m=1, 2, . . . , n). First of all, a condition is imposed that q_{(k,l)}^{(m,s)} should lie inside a quadrilateral defined by the following definitions (17) and (18). Then, the applicable mappings are narrowed down by selecting ones that are thought to be reasonable or natural among them satisfying the BC.

q_{g}_{^{(m,s)}}_{(i-1,j-1)}^{(m,s)}q_{g}_{^{(m,s)}}_{(i-1,j+1)}^{(m,s)}q_{g}_{^{(m,s)}}_{(i+1,j+1)}^{(m,s)}q_{g}_{^{(m,s)}}_{(i+1,j-1)}^{(m,s)} (17)

where

g^{(m,s)}(i,j)=f^{(m-1,s)}(parent(i,j))+f^{(m-1,s)}(parent(i,j)+(1,1)) (18)

The quadrilateral defined above is hereinafter referred to as the inherited quadrilateral of p_{(i,j)}^{(m,s)}. The pixel minimizing the energy is sought and obtained inside the inherited quadrilateral.

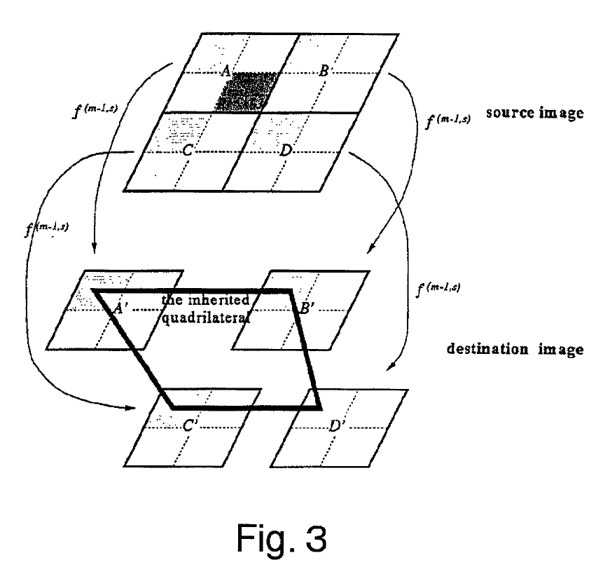

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above may now be replaced by the following equations (19) and (20):

E₀_{_{(i,j)}}=||f^{(m,0)}(i,j)−g^{(m)}(i,j)||² (19)

E₀_{_{(i,j)}}=||f^{(m,s)}i,j)−f^{(m,s-1)}(i,j)||², (1≦i) (20)

for computing the submapping f^{(m,0)} and the submapping f^{(m,s)} at the m-th level, respectively.

In this manner, a mapping which maintains a low energy of all the submappings is obtained. Using the equation (20) makes the submappings corresponding to the different critical points associated to each other within the same level in order that the subimages can have high similarity. The equation (19) represents the distance between f^{(m,s)}(i,j) and the location where (i,j) should be mapped when regarded as a part of a pixel at the (m−1) the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)}(i,j). L is increased until such a pixel is found or L reaches its upper bound Lₘₐₓ^{(m)}. Lₘₐₓ^{(m)} is fixed for each level m. If no pixel is found at all, the third condition of the BC is ignored temporarily and such mappings that caused the area of the transformed quadrilateral to become zero (a point or a line) will be permitted so as to determine f^{(m,s)}(i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will generally be limited to a very small size, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1.4] Automatic Determination of the Optimal Parameter Values

One of the main deficiencies of the existing image matching techniques lies in the difficulty of parameter adjustment. In most cases, the parameter adjustment is performed manually and it is extremely difficult to select the optimal value. However, according to the base technology, the optimal parameter values can be obtained completely automatically.

The systems according to this base technology include two parameters, namely, λ and η, where λ and η represent the weight of the difference of the pixel intensity and the stiffness of the mapping, respectively. In order to automatically determine these parameters, the are initially set to 0. First, λ is gradually increased from λ=0 while η is fixed at 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena occur:

1. Pixels which should not be corresponded are erroneously corresponded only because their intensities are close.

2. As a result, correspondence between images becomes inaccurate, and the mapping becomes invalid.

3. As a result, D_{f}^{(m,s)} in equation (14) tends to increase abruptly.

4. As a result, since the value of equation (14) tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which equation (14) takes the minimum value with λ being increased is kept. Such λ is determined as the optimal value at η=0. Next, the behavior of C_{f}^{(m,s)} is examined while η is increased gradually, and η will be automatically determined by a method described later. λ will then again be determined corresponding to such an automatically determined η.

The above-described method resembles the focusing mechanism of human visual systems. In the human visual systems, the images of the respective right eye and left eye are matched while moving one eye. When the objects are clearly recognized, the moving eye is fixed.

[1.4.1] Dynamic Determination of λ

Initially, λ is increased from 0 at a certain interval, and a subimage is evaluated each time the value of λ changes. As shown in equation (14), the total energy is defined by λC_{f}^{(m,s)}+D_{f}^{(m,s)}. D_{(i,j)}^{(m,s)} in equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, it is impossible to change the mapping to reduce the total energy unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(l), where h(l) is the number of pixels whose energy C_{(i,j)}^{(m,s)} is l². In order that λl²≧1 for example, the case of l²=1/λ is considered. When λ varies from λ₁ to λ₂, a number of pixels (denoted A) expressed by the following equation (21):

$$A = {\sum }_{l = ⌈ \frac{1}{{λ}_{2}} ⌉}^{⌊ \frac{1}{{λ}_{1}} ⌋} h ( l ) ≅ {\int }_{l = \frac{1}{{λ}_{2}}}^{\frac{1}{{λ}_{1}}} h ( l ) ⅆ l = - {\int }_{{λ}_{2}}^{{λ}_{1}} h ( l ) \frac{1}{{λ}^{3 / 2}} ⅆ λ = {\int }_{{λ}_{1}}^{{λ}_{2}} \frac{h ( l )}{{λ}^{3 / 2}} ⅆ λ \qquad ( 21 )$$

changes to a more stable state having the energy shown in equation (22):

$${C}_{f}^{( m , s )} - {l}^{2} = {C}_{f}^{( m , s )} - \frac{1}{λ} . \qquad ( 22 )$$

Here, it is assumed that the energy of these pixels is approximated to be zero. This means that the value of C_{(i,j)}^{(m,s)} changes by:

$$\partial {C}_{f}^{( m , s )} = - \frac{A}{λ} \qquad ( 23 )$$

As a result, equation (24) holds.

$$\frac{\partial {C}_{f}^{( m , s )}}{\partial λ} = - \frac{h ( l )}{{λ}^{5 / 2}} \qquad ( 24 )$$

Since h(l)>0, C_{f}^{(m,s)} decreases in the normal case. However, when λ exceeds the optimal value, the above phenomenon, that is, an increase in C_{f}^{(m,s)} occurs. The optimal value of λ is determined by detecting this phenomenon.

When

$$h ( l ) = H {l}^{k} = \frac{H}{{λ}^{k / 2}} \qquad ( 25 )$$

is assumed, where both H(H>0) and k are constants, the equation (26) holds:

$$\frac{\partial {C}_{f}^{( m , s )}}{\partial λ} = - \frac{H}{{λ}^{5 / 2 + k / 2}} \qquad ( 26 )$$

Then, if k≠−3, the following equation (27) holds:

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed as a value p₀ here. In this case, since

$$\frac{\partial A}{\partial λ} = \frac{h ( l )}{{λ}^{3 / 2}} \qquad ( 28 )$$

holds, the number of pixels violating the BC increases at a rate of:

$$\begin{matrix}{B}_{0} = \frac{h ( l ) {p}_{0}}{{λ}^{3 / 2}} \\ T h u s , & ( 29 ) \\ \frac{{B}_{0} {λ}^{3 / 2}}{{p}_{0} h ( l )} = 1 & ( 30 )\end{matrix}$$

is a constant. If it is assumed that h(l)=Hl^{k}, the following equation (31), for example,

B₀λ^{3/2+k/2}=p₀H (31)

becomes a constant. However, when λ exceeds the optimal value, the above value of equation (31) increases abruptly. By detecting this phenomenon, i.e. whether or not the value of B₀λ^{3/2+k/2}/2′″ exceeds an abnormal value B₀ₜₕᵣₑₛ, the optimal value of λ can be determined. Similarly, whether or not the value of B₁λ^{3/2+k/2}/2′″ exceeds an abnormal value B₁ₜₕᵣₑₛ can be used to check for an increasing rate B₁ of pixels violating the third condition of the BC. The reason why the factor 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect excessive distortion of the mapping which may not be detected through observation of the energy C_{f}^{(m,s)}.

In the experimentation, when λ exceeded 0.1 the computation of f^{(m,s)} was stopped and the computation of f^{(m,s+1)} was started. That is because the computation of submappings is affected by a difference of only 3 out of 255 levels in pixel intensity when λ>0.1 and it is then difficult to obtain a correct result.

[1.4.2] Histogram h(l)

The examination of C_{f}^{(m,s)} does not depend on the histogram h(l), however, the examination of the BC and its third condition may be affected by h(l). When (λ, C_{f}^{(m,s)}) is actually plotted, k is usually close to 1. In the experiment, k=1 is used, that is, B₀λ² and B₁λ² are examined. If the true value of k is less than 1, B₀λ² and B₁λ² are not constants and increase gradually by a factor of λ^{(1-k)/2}. If h(l) is a constant, the factor is, for example, λ^{1/2}. However, such a difference can be absorbed by setting the threshold B₀ₜₕᵣₑₛ appropriately.

Let us model the source image by a circular object, with its center at (x₀, y₀) and its radius r, given by:

$$p ( i , j ) = \{ \begin{matrix} \frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( o t h e r w i s e )\end{matrix} \qquad ( 32 )$$

and the destination image given by:

$$q ( i , j ) = \{ \begin{matrix} \frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( o t h e r w i s e )\end{matrix} \qquad ( 33 )$$

with its center at (x₁, y₁) and radius r. In the above, let c(x) have the form of c(x)=x^{k}. When the centers (x₀, y₀) and (x₁, y₁) are sufficiently far from each other, the histogram h(l) is then in the form:

h(l)∝rl^{k}(k≠0) (34)

When k=1, the images represent objects with clear boundaries embedded in the background. These objects become darker toward their centers and brighter toward their boundaries. When k=−1, the images represent objects with vague boundaries. These objects are brightest at their centers, and become darker toward their boundaries. Without much loss of generality, it suffices to state that objects in images are generally between these two types of objects. Thus, choosing k such that −1≦k≦1 can cover most cases and the equation (27) is generally a decreasing function for this range.

As can be observed from the above equation (34), attention must be directed to the fact that r is influenced by the resolution of the image, that is, r is proportional to 2^{m}. This is the reason for the factor 2^{m} being introduced in the above section [1.4.1].

[1.4.3] Dynamic Determination of η

The parameter η can also be automatically determined in a similar manner. Initially, η is set to zero, and the final mapping f⁽ⁿ⁾ and the energy C_{f}⁽ⁿ⁾ at the finest resolution are computed. Then, after η is increased by a certain value Δη, the final mapping f⁽ⁿ⁾ and the energy C_{f}⁽ⁿ⁾ at the finest resolution are again computed. This process is repeated until the optimal value of η is obtained. η represents the stiffness of the mapping because it is a weight of the following equation (35):

E_{0(i,j)}^{(m,s)}=||f^{(m,s)}(i,j)−f^{(m,s-1)}(i,j)||² (35)

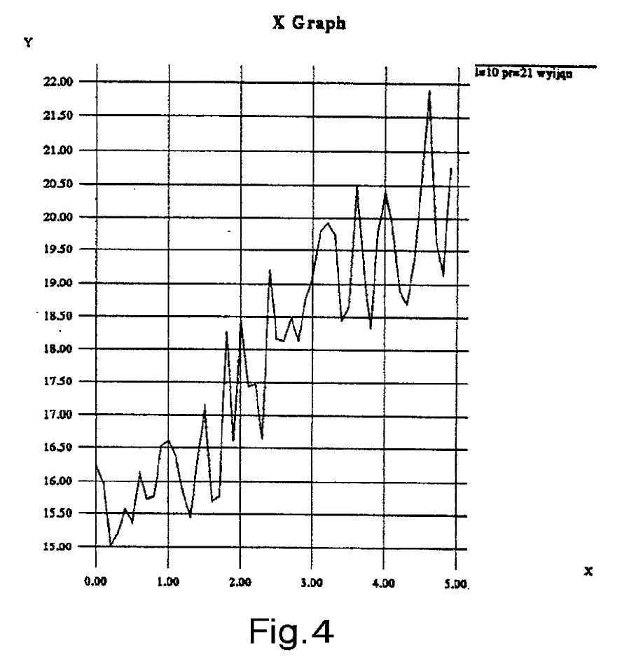

If η is zero, D_{f}⁽ⁿ⁾ is determined irrespective of the previous submapping, and the present submapping may be elastically deformed and become too distorted. On the other hand, if η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affect this computation as compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of η. Thus, whether the obtained value of C_{f}⁽ⁿ⁾ is the minimum or not cannot be determined as easily. When candidates for the minimum value are found, the true minimum needs to be searched by setting up further finer intervals.

[1.5] Supersampling

When deciding the correspondence between the pixels, the range of f^{(m,s)} can be expanded to R×R (R being the set of real numbers) in order to increase the degree of freedom. In this case, the intensity of the pixels of the destination image is interpolated, to provide f^{(m,s)} having an intensity at non-integer points:

V(q_{f}_{^{(m,s)}}_{(i,j)}^{(m,s)}) (36)

That is, supersampling is performed. In an example implementation, f^{(m,s)} may take integer and half integer values, and

V(q_{(i,j)+(0.5,0.5)}^{(m,s)} (37)

is given by

(V(q_{(i,j)}^{(m,s)})+V(q_{i,j)+(1,1)}^{(m,s)}))/2 (38)

[1.6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} and thus making it difficult to obtain an accurate evaluation.

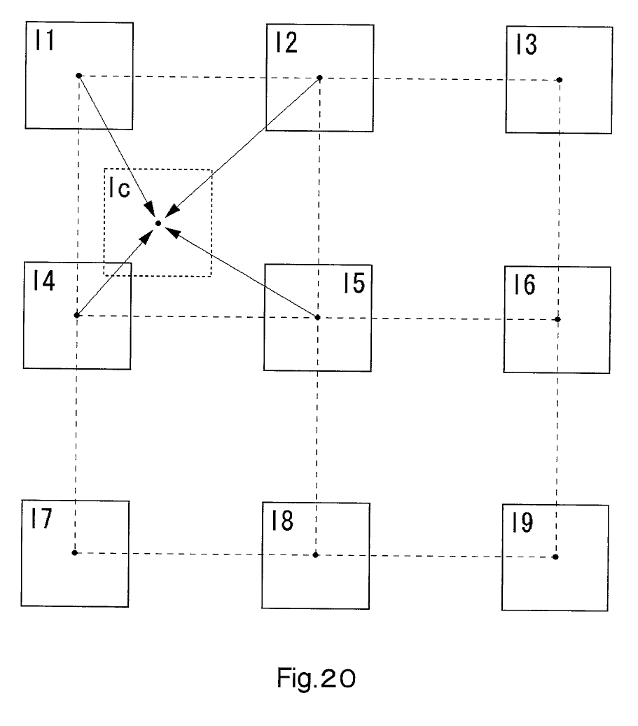

For example, a matching between a human face and a cat's face is computed as shown in FIGS. 20(a) and 20(b). The cat's face is covered with hair and is a mixture of very bright pixels and very dark pixels. In this case, in order to compute the submappings of the two faces, subimages are normalized. That is, the darkest pixel intensity is set to 0 while the brightest pixel intensity is set to 255, and other pixel intensity values are obtained using linear interpolation.

[1.7] Implementation

In an example implementation, a heuristic method is utilized wherein the computation proceeds linearly as the source image is scanned. First, the value of f^{(m,s)} is determined at the top leftmost pixel (i,j)=(0,0). The value of each f^{(m,s)}(i,j) is then determined while i is increased by one at each step. When i reaches the width of the image, j is increased by one and i is reset to zero. Thereafter, f^{(m,s)}(i,j) is determined while scanning the source image. Once pixel correspondence is determined for all the points, it means that a single mapping f^{(m,s)} is determined.

When a corresponding point q_{f(i,j)} is determined for p_{(i,j)}, a corresponding point q_{f(i,j+1)} of p_{(i,j+1)} is determined next. The position of q_{f(i,j+1)} is constrained by the position of q_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, f^{(m,s)} is determined starting from the top rightmost location while decreasing i and increasing j. When (s mod 4) is 2, f^{(m,s)} is determined starting from the bottom rightmost location while decreasing both i and j. When (s mod 4) is 3, f^{(m,s)} is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In this implementation, the values of f^{(m,s)}(i,j) (m=0, . . . , n) that satisfy the BC are chosen as much as possible from the candidates (k,l) by imposing a penalty on the candidates violating the BC. The energy D_{(k,l)} of a candidate that violates the third condition of the BC is multiplied by ø and that of a candidate that violates the first or second condition of the BC is multiplied by ψ. In this implementation, ø=2 and ψ=100000 are used.

In order to check the above-mentioned BC, the following test may be performed as the procedure when determining (k,l)=f^{(m,s)}(i,j). Namely, for each grid point (k,l) in the inherited quadrilateral of f^{(m,s)}(i,j), whether or not the z-component of the outer product of

W=\vec{A}×\vec{B} (39)

is equal to or greater than 0 is examined, where

$$\begin{matrix}\vec{A} = \vec{{q}_{{f}^{( m , s )} ( i , j - 1 )}^{( m , s )} {q}_{{f}^{( m , s )} ( i + 1 , j - 1 )}^{( m , s )}} & ( 40 ) \\ \vec{B} = \vec{{q}_{{f}^{( m , s )} ( i , j - 1 )}^{( m , s )} {q}_{{f}^{( k , l )}}^{( m , s )}} & ( 41 )\end{matrix}$$

Here, the vectors are regarded as 3D vectors and the z-axis is defined in the orthogonal right-hand coordinate system. When W is negative, the candidate is imposed with a penalty by multiplying D_{(k,l)}^{(m,s)} by ψ so that it is not as likely to be selected.

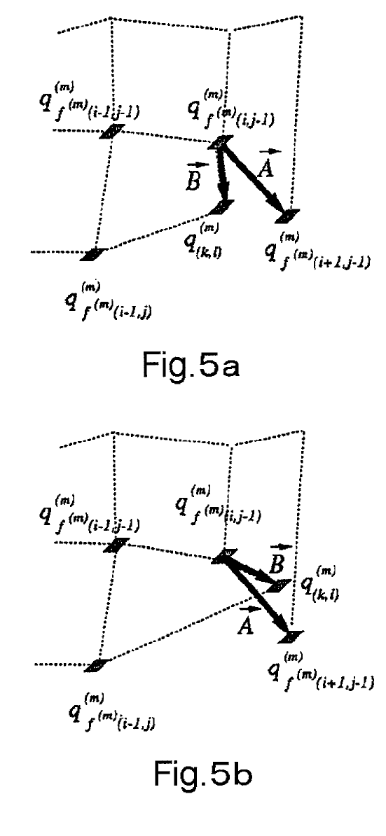

FIGS. 5(a) and 5(b) illustrate the reason why this condition is inspected. FIG. 5(a) shows a candidate without a penalty and FIG. 5(b) shows one with a penalty. When determining the mapping f^{(m,s)}(i, j+1) for the adjacent pixel at (i, j+1), there is no pixel on the source image plane that satisfies the BC if the z-component of W is negative because then q_{(k,l)}^{(m,s)} passes the boundary of the adjacent quadrilateral.

[1.7.1] The Order of Submappings

In this implementation, σ(0)=0, σ(1)=1, σ(2)=2, σ(3)=3, σ(4)=0 are used when the resolution level is even, while σ(0)=3, σ(1)=2, σ(2)=1, σ(3)=0, σ(4)=3 are used when the resolution level is odd. Thus, the submappings are shuffled to some extent. It is to be noted that the submappings are primarily of four types, and s may be any of 0 to 3. However, a processing with s=4 is used in this implementation for a reason to be described later.

[1.8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1, j+1)}p_{(i, j+1)} on the source image plane is mapped to a quadrilateral q_{f(i,j)}q_{f(i+1, j)}q_{f(i+1, j+1)}q_{f(i,j+1)} on the destination image plane. For simplicity, the distance between the image planes is assumed to be 1. The intermediate image pixels r(x,y,t) (0≦x≦N−1, 0≦y≦M−1 whose distance from the source image plane is t (0≦t≦1) are obtained as follows. First, the location of the pixel r(x,y,t), where x,y,tεR, is determined by equation (42):

$$( x , y ) = ( 1 - d x ) ( 1 - d y ) ( 1 - t ) ( i , j ) + ( 1 - d x ) ( 1 - d y ) tf ( i , j ) + d x ( 1 - d y ) ( 1 - t ) ( i + 1 , j ) + d x ( 1 - d y ) tf ( i + 1 , j ) + ( 1 - d x ) d y ( 1 - t ) ( i , j + 1 ) + ( 1 - d x ) dytf ( i , j + 1 ) + d x d y ( 1 - t ) ( i + 1 , j + 1 ) + d x d y tf ) I + 1 , j + 1 ) \qquad ( 42 )$$

The value of the pixel intensity at r(x,y,t) is then determined by equation (43):

$$V ( r ( x , y , t ) ) = ( 1 - d x ) ( 1 - d y ) ( 1 - t ) V ( {p}_{( i , j )} ) + ( 1 - d x ) ( 1 - d y ) t V ( {q}_{f ( i , j )} ) + d x ( 1 - d y ) ( 1 - t ) V ( {p}_{( i + 1 , j )} ) + d x ( 1 - d y ) t V ( {q}_{f ( i + 1 , j )} ) + ( 1 - d x ) d y ( 1 - t ) V ( {p}_{( i , j + 1 )} ) + ( 1 - d x ) d y t V ( {q}_{f ( i , j + 1 )} ) + d x d y ( 1 - t ) V ( {p}_{( i + 1 , j + 1 )} ) + d x d y t V ( {q}_{f ( i + 1 , j + 1 )} ) \qquad ( 43 )$$

where dx and dy are parameters varying from 0 to 1.

[1.9] Mapping to Which Constraints are Imposed

So far, the determination of a mapping in which no constraints are imposed has been described. However, if a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination image and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of a specified pixel are mapped to locations near the position to which the specified one is mapped. Here, the approximate mapping at the m-th level in the resolution hierarchy is denoted by F^{(m)}.

The approximate mapping F is determined in the following manner. First, the mappings for several pixels are specified. When n, pixels

p(i₀, j₀), p(i₁, j₁), . . . , p(iₙ_{ₛ}₋₁, jₙ_{ₛ}₋₁) (44)

of the source image are specified, the following values in the equation (45) are determined.

F⁽ⁿ⁾(i₀, j₀)=(k₀, l₀),

F⁽ⁿ⁾(i₁, f₁)=(k₁, l₁), . . . ,

F⁽ⁿ⁾(iₙ₋₁, jₙ₋₁)=(kₙ_{ₛ}₋₁, lₙ_{ₛ}₋₁) (45)

For the remaining pixels of the source image, the amount of displacement is the weighted average of the displacement of P(iₕ, jₕ) (h=0, . . . , nₛ−1). Namely, a pixel p_{(i,j)} is mapped to the following pixel (expressed by the equation (46)) of the destination image.

$$\begin{matrix}{F}^{( m )} ( i , j ) = \frac{( i , j ) + {\sum }_{h = 0}^{h = {n}_{s} - 1} ( {k}_{h} - {i}_{h} , {l}_{h} - {j}_{h} ) w e i g h {t}_{h} ( i , j )}{{2}^{n - m}} \\ w h e r e & ( 46 ) \\ w e i g h {t}_{h} ( i , j ) = \frac{1 / {‖ ( {i}_{h} - i , {j}_{h} - j ) ‖}^{2}}{total\_weight ( i , j )} \\ w h e r e & ( 47 ) \\ total\_weight ( i , j ) = {\sum }_{h = 0}^{h = {n}_{s} - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that a mapping f similar to F^{(m)} has a lower energy. Precisely speaking, D_{(i,j)}^{(m,s)} is expressed by the equation (49):

D_{(i,j)}^{(m,s)}=E₀_{_{(i,j)}}^{(m,s)}+ηEₗ_{_{(i,j)}}^{(m,s)}+κE₂_{_{(i,j)}}^{(m,s)} (49)

where

$${E}_{{2}_{( i , j )}}^{( m , s )} = \{ \begin{matrix}0 , i f {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , o t h e r w i s e\end{matrix} \qquad ( 50 )$$

where κ, p≧0. Finally, the resulting mapping f is determined by the above-described automatic computing process.

Note that E₂_{_{(i,j)}}^{(m,s)} becomes 0 if f^{(m,s)}(i,j) is sufficiently close to F^{(m)}(i,j) i.e., the distance therebetween is equal to or less than

$$⌊ \frac{{ρ}^{2}}{{2}^{2 ( n - m )}} ⌋ \qquad ( 51 )$$

This has been defined in this way because it is desirable to determine each value f^{(m,s)}(i,j) automatically to fit in an appropriate place in the destination image as long as each value f^{(m,s)}(i,j) is close to F^{(m)}(i,j). For this reason, there is no need to specify the precise correspondence in detail to have the source image automatically mapped so that the source image matches the destination image.

[2] Concrete Processing Procedure

The flow of a process utilizing the respective elemental techniques described in [1] will now be described.

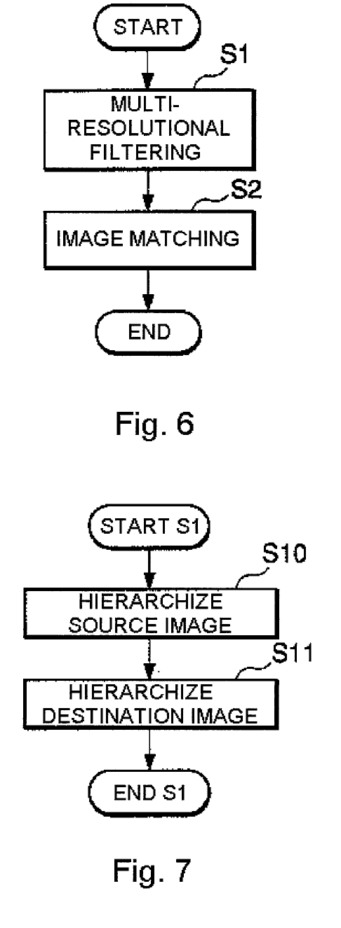

FIG. 6 is a flowchart of the overall procedure of the base technology. Referring to FIG. 6, a source image and destination image are first processed using a multiresolutional critical point filter (S1). The source image and the destination image are then matched (S2). As will be understood, the matching (S2) is not required in every case, and other processing such as image recognition may be performed instead, based on the characteristics of the source image obtained at S1.

FIG. 7 is a flowchart showing details of the process S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel. It may also be possible to process a number of source and destination images as required by subsequent processes.

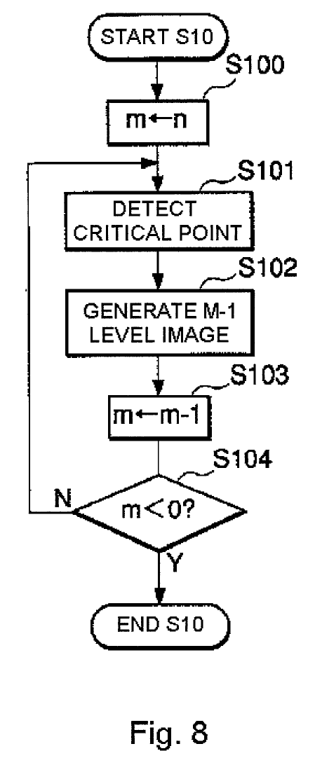

FIG. 8 is a flowchart showing details of the process at S10 shown in FIG. 7. Suppose that the size of the original source image is 2ⁿ×2ⁿ. Since source hierarchical images are sequentially generated from an image with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{(m-1,2)} and p^{(m-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

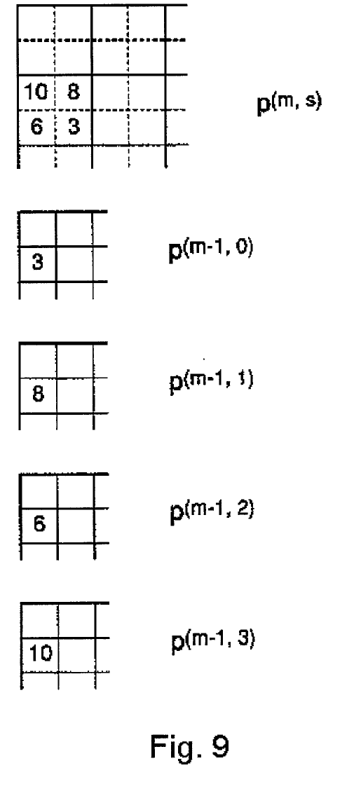

FIG. 9 shows correspondence between partial images of the m-th and those of (m−1)th levels of resolution. Referring to FIG. 9, respective numberic values shown in the figure represent the intensity of respective pixels. p^{(m,s)} symbolizes any one of four images p^{(m,0)} through p^{(m,3)}, and when generating p^{(m-1,0)}, p^{(m,0)} is used from p^{(m,s)}. For example, as for the block shown in FIG. 9, comprising four pixels with their pixel intensity values indicated inside, images p^{(m-1,0)}, p^{(m-1,1)}, p^{(m-1,2)} and p^{(m-1,3)} acquire “3”, “8”, “6” and “10”, respectively, according to the rules described in [1.2]. This block at the m-th level is replaced at the (m−1)th level by respective single pixels thus acquired. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

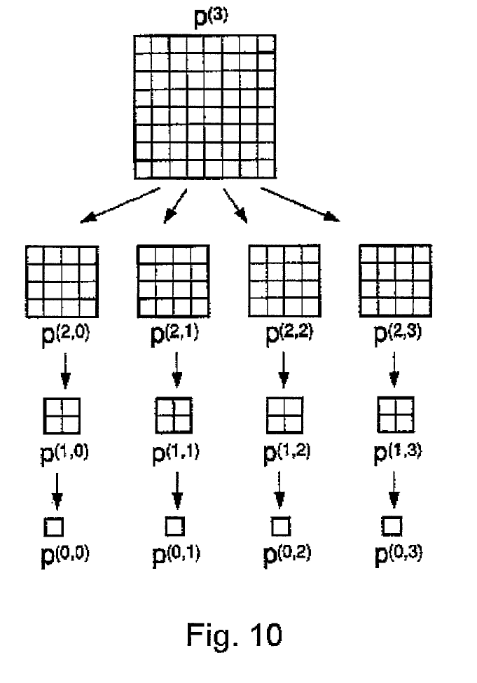

FIG. 10 shows source hierarchical images generated at S10 in the case of n=3. The initial source image is the only image common to the four series followed. The four types of subimages are generated independently, depending on the type of critical point. Note that the process in FIG. 8 is common to S11 shown in FIG. 7, and that destination hierarchical images are generated through a similar procedure. Then, the process at S1 in FIG. 6 is completed.

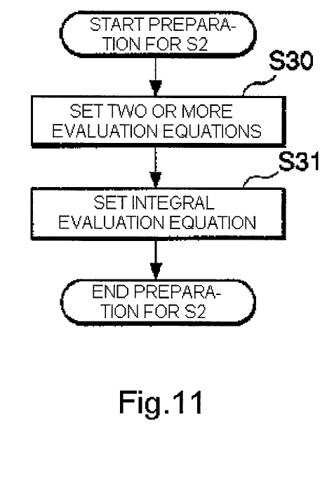

In this base technology, in order to proceed to S2 shown in FIG. 6 a matching evaluation is prepared. FIG. 11 shows the preparation procedure. Referring to FIG. 11, a plurality of evaluation equations are set (S30). The evaluation equations may include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such a combined evaluation equation may be λC_{(i,j)}^{(m,s)}+D_{f}^{(m,s)}. Using η introduced in [1.3.2.2], we have

ΣΣ(λC_{(i,j)}^{(m,s)}+ηE_{0(i,j)}^{(m,s)}+E_{1(i,j)}^{(m,s)} (52)

In the equation (52) the sum is taken for each i and j where i and j run through 0, 1, . . . , 2^{m-1}. Now, the preparation for matching evaluation is completed.

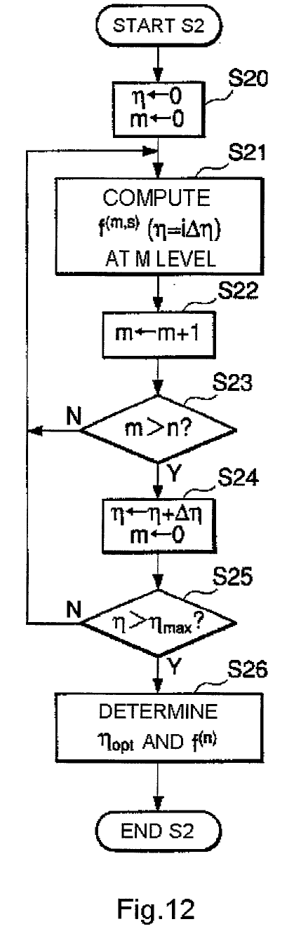

FIG. 12 is a flowchart showing the details of the process of S2 shown in FIG. 6. As described in [1], the source hierarchical images and destination hierarchical images are matched between images having the same level of resolution. In order to detect global correspondence correctly, a matching is calculated in sequence from a coarse level to a fine level of resolution. Since the source and destination hierarchical images are generated using the critical point filter, the location and intensity of critical points are stored clearly even at a coarse level. Thus, the result of the global matching is superior to conventional methods.

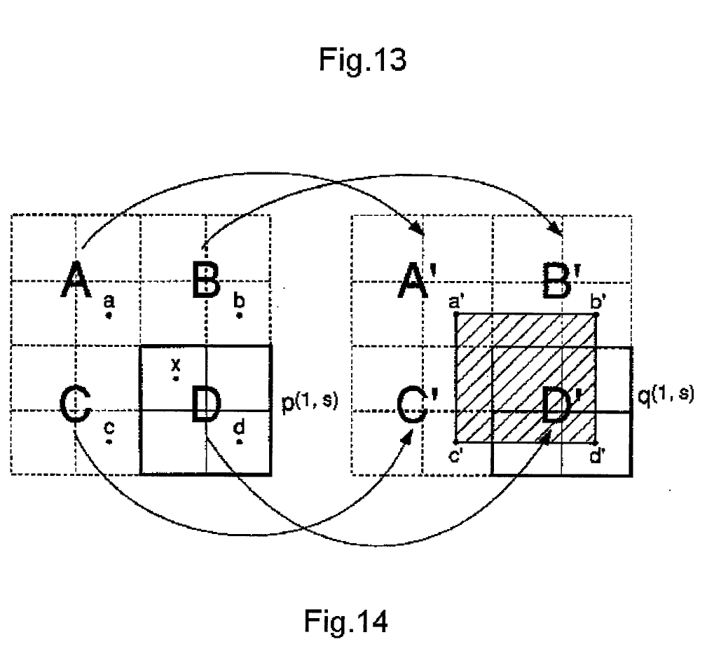

Referring to FIG. 12, a coefficient parameter n and a level parameter m are set to 0 (S20). Then, a matching is computed between the four subimages at the m-th level of the source hierarchical images and those of the destination hierarchical images at the m-th level, so that four types of submappings f^{(m,s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is called a vertical reference between different levels. If m=0, there is no coarser level and this exceptional case will be described using FIG. 13.

A horizontal reference within the same level is also performed. As indicated by the equation (20) in [1.3.3], f^{m,3)}, f^{(m,2)} and f^{m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one may be referred to since there is no other submapping at the same level to be referred to as shown in the equation (19). In this base technology, however, a procedure is adopted such that after the submappings were obtained up to f^{(m,3)}, f^{(m,0)} is recalculated once utilizing the thus obtained subamppings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is consitituted by a single pixel, the four submappings f^{(0,s)} are automatically chosen as the identity mapping. FIG. 14 shows how the submappings are determined at the first level. At the first level, each of the sub-images is constituted of four pixels, which are indicated by solid lines. When a corresponding point (pixel) of the point (pixel) x in p^{(1,s)} is searched within q^{(1,s)}, the following procedure is adopted:

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the pixels A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the lower right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾(η=0) because it has been determined relative to η=0.

Next, to obtain the mapping with respect to other different η, η is shifted by Δη and m is reset to zero (S24). After confirming that new η does not exceed a predetermined search-stop value ηₘₐₓ(S25), the process returns to S21 and the mapping f⁽ⁿ⁾ (η=Δη) relative to the new η is obtained. This process is repeated while obtaining f⁽ⁿ⁾(η=iΔη)(i=0, 1, . . . ) at S21. When η exceeds ηₘₐₓ, the process proceeds to S26 and the optimal η=ηₒₚₜ is determined using a method described later, so as to let f⁽ⁿ⁾(η=ηₒₚₜ) be the final mapping f⁽ⁿ⁾.

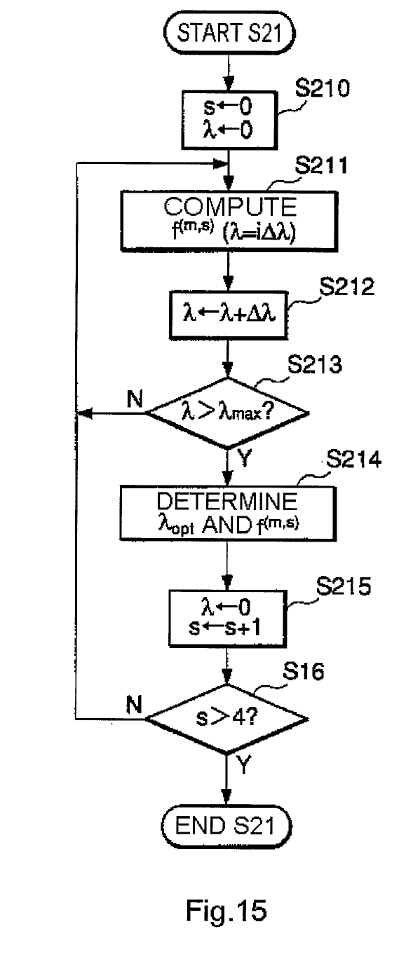

FIG. 15 is a flowchart showing the details of the process of S21 shown in FIG. 12. According to this flowchart, the submappings at the m-th level are determined for a certain predetermined η. In this base technology, when determining the mappings, the optimal λ is defined independently for each submapping.

Referring to FIG. 15, s and λ are first reset to zero (S210). Then, obtained is the submapping f^{(m,s)} that minimizes the energy with respect to the then λ (and, implicitly, η) (S211), and the thus obtained submapping is denoted as f^{(m,s)}(λ=0). In order to obtain the mapping with respect to other different λ, λ is shifted by Δλ. After confirming that the new λ does not exceed a predetermined search-stop value λₘₐₓ (S213), the process returns to S211 and the mapping f^{(m,s)}(λ=Δλ) relative to the new λ is obtained. This process is repeated while obtaining f^{(m,s)}(λ=iΔλ)(i=0, 1, . . . ). When λ exceeds λₘₐₓ, the process proceeds to S214 and the optimal λ=λₒₚₜ is determined, so as to let f⁽ⁿ⁾(λ=λₒₚₜ) be the final mapping f^{(m,s)}(S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

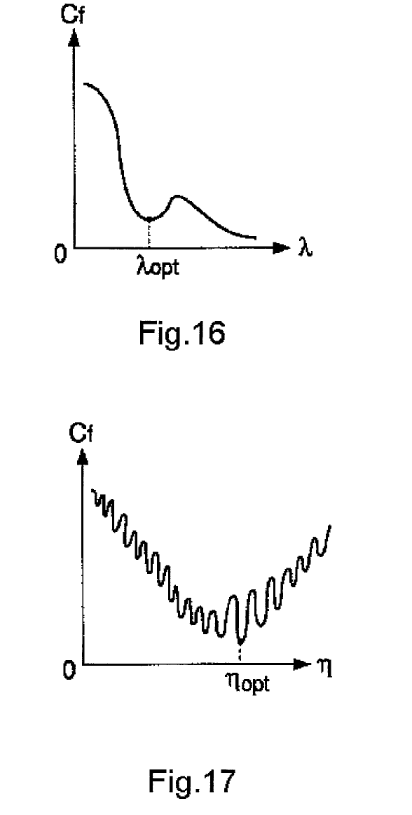

FIG. 16 shows the behavior of the energy C_{f}^{(m,s)} corresponding to f^{(m,s)}(λ=iΔλ)(i=0, 1, . . . ) for a certain m and s while varying λ. As described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} begins to decrease again in the range λ>λₒₚₜ, the mapping will not be as good. For this reason, it suffices to pay attention to the first occurring minima value. In this base technology, λₒₚₜ is independently determined for each submapping including f⁽ⁿ⁾.

FIG. 17 shows the behavior of the energy C_{f}⁽ⁿ⁾ corresponding to f⁽ⁿ⁾(η=iΔη)(i=0, 1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to object recognition, characteristic extraction, and image matching. As a result, it is possible to construct an image processing system which significantly reduces manual labor.

Some further extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ as in the base technology, or more than two parameters. When there are more than three parameters used, they may be determined while changing one at a time.

(2) In the base technology, a parameter is determined in a two-step process. That is, in such a manner that a point at which C_{f}^{(m,s)} takes the minima is detected after a mapping such that the value of the combined evaluation equation becomes minimum is determined. However, instead of this two-step processing, a parameter may be effectively determined, as the case may be, in a manner such that the minimum value of a combined evaluation equation becomes minimum. In this case, αE₀+βE₁, for example, may be used as the combined evaluation equation, where α+β=1 may be imposed as a constraint so as to equally treat each evaluation equation. The automatic determination of a parameter is effective when determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes ¼. However, it is possible to suppose that one block consists of 3×3 pixels and critical points are searched in this 3×3 block, then the number of pixels will be 1/9 as the level advances by one.

(5) In the base technology, if the source and the destination images are color images, they would generally first be converted to monochrome images, and the mappings then computed. The source color images may then be transformed by using the mappings thus obtained. However, as an alternate method, the submappings may be computed regarding each RGB component.

Preferred Embodiments for Image Interpolation

Image interpolation techniques utilizing the above-described base technology will now be described. According to these techniques, as verified experimentally, a rotary presentation of a product (i.e. views of an object from various viewpoints) can be performed with photos taken at intervals of 10 to 30 degrees, in contrast to intervals of about one degree required in conventional techniques. In other words, it is possible to provide an equal or superior presentation of a product using an amount of data that is generally 1/10 to 1/30 of the amount of data conventionally required.

FIG. 18 shows image frames used to explain the techniques according to a preferred embodiment. FIGS. 18A, 18B, 18C and 18D are key frames showing a coffee cup from different angles or viewpoints. The key frames are generally actual images prepared beforehand by conventional or digital photography or otherwise. An object of the present embodiment is to generate an intermediate frame, as shown for example in FIG. 18E, from the four key frames shown as FIG. 18A-18D. In order to do this, the key frame of FIG. 18A and the key frame of FIG. 18B form a first image pair, and the key frame of FIG. 18C and the key frame of FIG. 18D form a second image pair. Although, the desired intermediate frame cannot be generated correctly by interpolating either of the first image pair or the second image pair, the intermediate image may be generated by using both of the image pairs. According to the present embodiment, an intermediate frame is generated by interpolating a plurality of key frames in a number of dimensions, for example both vertical and horizontal directions.

In this preferred embodiment, by continuously generating intermediate frames according to a viewpoint of a user, what is called a “pseudo three-dimensional image”, which is basically a rotatable image of an object, can be realized using only a small number of key frames. This can be used for product presentation in electronic commerce, compression of motion pictures, image effects and so forth.

Generally, a method according to an embodiment of the invention may be summarized as including:

(1) acquiring a first image pair comprised of two key frames, and first corresponding point data between the two key frames;

(2) acquiring a second image pair comprised of two key frames, and second corresponding point data between the two key frames; and

(3) generating an intermediate frame by interpolation, by utilizing positional relations of a first axis and a second axis, the first corresponding point data and the second corresponding point data, where the first axis is determined temporally or spatially between the two key frames of the first image pair, and the second axis is determined temporally or spatially between the two key frames of the second image pair.

In the above (1) and (2), the first corresponding point data and the second corresponding point data may be obtained by a matching between the respective key frames. In the above (3), a bilinear interpolation may be performed using the first axis and the second axis. As an example, key frames obtained from two viewpoints that are p1(0,0) and p2 (0,100) serve as the first image pair while key frames obtained from another two viewpoints that are p3 (100,0) and p4 (100,100) serve as the second image pair. A straight line connecting frames p1 and p2 corresponds to the first axis while a straight line connecting frames p3 and p4 corresponds to the second axis.

Although in the above example the first axis and the second axis are spatially determined respectively between the two key frames, the first axis and the second axis may also be determined temporally. For example, it may be supposed that two key frames obtained from a viewpoint P at time t=t0 and t=t1 serve as the first image pair while two key frames obtained from another viewpoint Q at time t=t0 and t=t1 serve as the second image pair. In this case, a straight line connecting frame (P, t0) and frame (P, t1) in the fist image pair becomes the first axis, and similarly a straight line connecting frame (Q, t0) and frame (Q, t1) in the second image pair becomes the second axis. Thus, if an intermediate image from, for example, a point ((P+Q)/2, (t0+t1)/2) is required, intermediate-like images may be generated on the respective two axes and the intermediate-like images are then interpolated to create the desired intermediate image. In particular, the intermediate-like images may also be matched to produce a further corresponding point file for use in interpolation of the desired intermediate image.

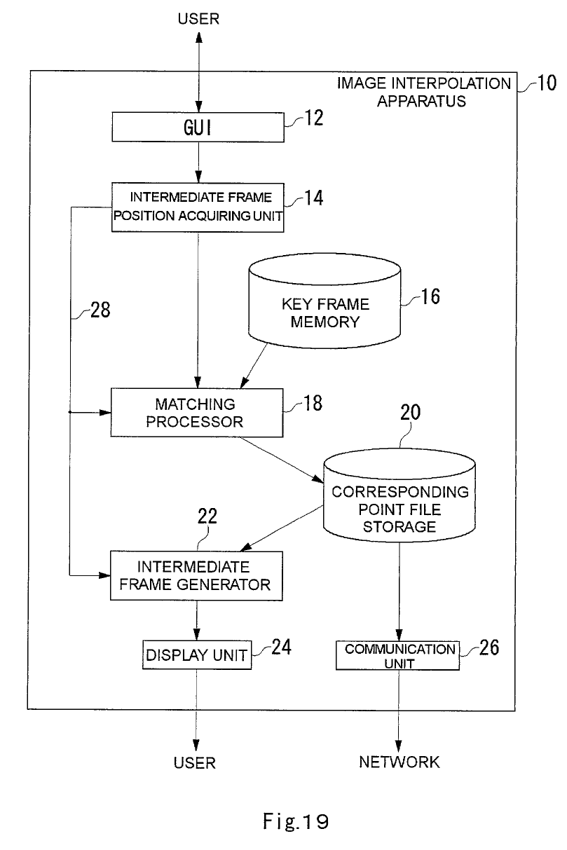

FIG. 19 shows a structure of an image interpolation apparatus 10 according to an embodiment of the present invention. The image interpolation apparatus 10 includes: a graphical user interface (GUI) 12 which interacts with a user; an intermediate frame position acquiring unit 14 which acquires via the GUI 12 positional information 28 on an intermediate frame to be generated; a key frame memory 16 which stores a plurality of key frames; a matching processor 18 which performs a matching computation based on the base technology by selecting from the key frame memory 16 key frames necessary for generating an intermediate frame according to the positional information 28; a corresponding point file storage unit 20 which records, as a corresponding point file, corresponding point data between the key frames thus obtained; and an intermediate frame generator 22 which generates an intermediate frame by an interpolation computation using the corresponding point files and the positional information 28. The image interpolation apparatus 10 further includes a display unit 24 which displays generated intermediate frames, preferably in a continuous or “real-time” manner, according to the user's instructions or viewpoint, and a communication unit 26 for communicating the corresponding point file to an external unit (not shown) based on an external request or the like through a network or the like.

FIG. 20 shows a positional relationship of an intermediate frame and spatially distributed key frames I1-9. In particular, in FIG. 20 the key frames I1-9 are arranged according to the viewpoint positions at which they were photographed or captured, and the intermediate frame Ic to be generated is positioned according to a virtual viewpoint position, as specified by a user.

In this particular example, there are nine key frames, namely, a first key frame I1 through a ninth key frame I9. Now, after the position of the intermediate frame Ic to be generated is acquired via the GUI 12, the key frames surrounding the intermediate frame Ic (hereinafter referred to as reference key frames or key frames of interest) are first identified. In this case, the reference key frames are the first key frame I1, second key frame I2, fourth key frame I4 and fifth key frame I5. Further, the first key frame I1 and the second key frame I2 are set as the first image pair, and the fourth key frame I4 and the fifth key frame I5 are set as the second image pair. The position occupied by the intermediate frame Ic inside a quadrilateral formed by these four key frames is then determined geometrically and an image of the intermediate frame is generated by interpolation (as described hereinafter).

In this way, a position occupied by the intermediate frame Ic relative to the reference key frames is determined by the intermediate frame position acquiring unit 14. The reference key frames and the position of the intermediate frame Ic are communicated to the matching processor 18, where a matching computation based on the base technology is performed between the first image pair and the second image pair. The results of each matching are recorded in the corresponding point file storage unit 20 as corresponding point files.

The position of the intermediate frame acquired by the intermediate frame position acquiring unit 14 (“position information”) is also sent to the intermediate frame generator 22. The intermediate frame generator 22 carries out an interpolation computation using the position information and the two corresponding point files.

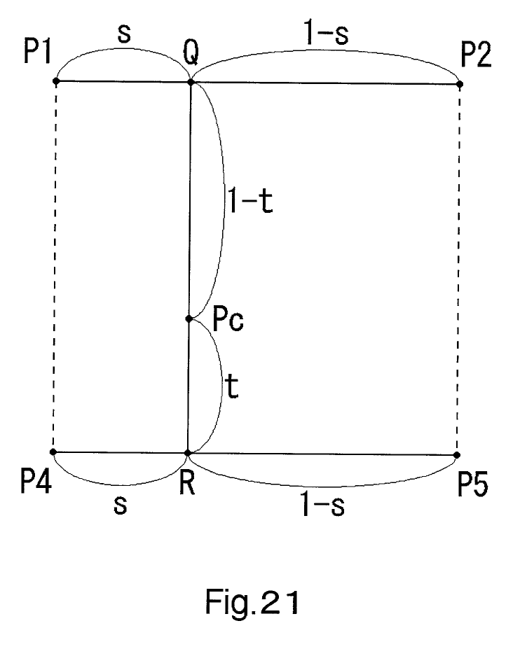

FIG. 21 shows an example of a method of interpolation according to an embodiment of the invention. Here, it is supposed that when the first key frame I1, the second key frame I2, the fourth key frame I4 and the fifth key frame I5 may be represented typically by points P1, P2, P4 and P5, respectively. Further, the position of a point Pc, represents the intermediate frame. Now, the point Pc, within the quadrilateral defined by the points P1, P2, P4 and P5 satisfies the following:

“The point Pc divides at a ratio of (1−t):t the line segment between a point Q, which divides the line connecting P1 and P2 at a ratio of s:(1−s), and a point R, which divides the line connecting P4 and P5 at a ratio of s:(1−s), where s and t are real numbers between 0 and 1.”

Thus, the intermediate frame generator 22 first generates an image corresponding to the point Q by an interpolation at a ratio of s:(1−s) based on the corresponding point file for the first image pair. The intermediate frame generator 22 then generates an image corresponding to the point R by an interpolation at a ratio of s:(1−s) based on the corresponding point file for the second image pair image. Finally, the intermediate frame generator 22 then generates the intermediate image Ic by using these two images and an interpolation at a ratio of (1−t):t. As described above, in a particular case, a further corresponding point file may be generated by the matching processor 18 based on images corresponding to the points Q and R, for use in interpolation.

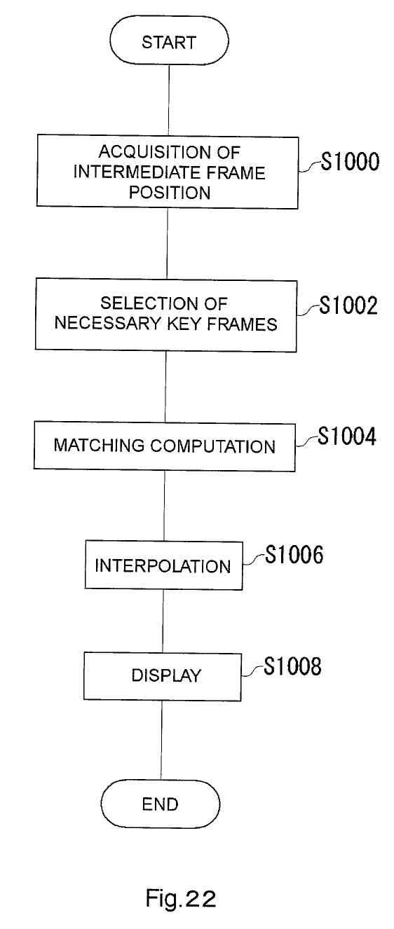

FIG. 22 shows a processing procedure that may be used by the image interpolation apparatus 10. Initially, the display unit 24 displays an arbitrary key frame. As an example, the fourth key frame I4 shown in FIG. 20 may be displayed. If the user moves a pointer (such as a mouse pointer or the like) on the screen toward the upper right while pressing a mouse button, then this movement may be interpreted as an instruction that the displayed product (not shown) is to be rotated in the upper right direction as seen from the user. Therefore, as shown in FIG. 20, the position of the intermediate frame Ic is to the upper right as seen from the fourth key frame I4. Now, based on the direction and distance of movement of the mouse, the intermediate frame position acquiring unit 14 acquires the position of the intermediate frame Ic (S1000).

Thereafter, the intermediate frame position acquiring unit 14 selects the above-described four key frames as the reference key frames (S1002) and conveys this information as well as the position information to the matching processor 18. The matching processor 18 reads out the images of those key frames from the key frame memory 16 and performs a matching computation on each of the first image pair and the second image pair (S1004). The results of the computation are stored in the corresponding point file storage unit 20 as two corresponding point files.

The intermediate frame generator 22 obtains the points Q and R in FIG. 21, individually, from these corresponding point files and then obtains the intermediate frame Ic by interpolation (S1006). Finally, the intermediate frame Ic generated as a result of mouse operation by the user is displayed (S1008). The corresponding point files may also be output to a network or the like as required.

Preferred embodiments according to the present invention have been described. In these embodiments, interpolation was performed based on a quadrilateral, but a triangle may also be used for interpolation. Moreover, the corresponding point files, which were generated for each interpolation, may be generated in advance by calculation between key frames. In such a modification, the intermediate frame will be generated more quickly, which is much more suitable for real-time product presentation.

Although the present invention has been described by way of exemplary embodiments, it should be understood that many changes and substitutions may be made by those skilled in the art without departing from the scope of the present invention which is defined by the appended claims.

What is claimed is:

1. An image interpolation method, comprising:
acquiring a first image pair, comprising two key frames, and first corresponding point data between the two key frames of the first image pair;
acquiring a second image pair, comprising two key frames, and second corresponding point data between the two key frames of the second image pair; and
generating an intermediate frame by interpolation, wherein the interpolation utilizes positional relations of a first axis and a second axis and the first corresponding point data and the second corresponding point data,
the first axis being determined temporally or spatially between the two key frames of the first image pair, and
the second axis being determined temporally or spatially between the two key frames of the second image pair.

2. A method according to claim 1, wherein the first image pair and the second image pair are determined so that the first axis and the second axis do not lie on a same line.

3. A method according to claim 1, wherein one of the two key frames in the first image pair and one of the two key frames in the second image pair are common, and the interpolation utilizes positional relations based on a triangle having the first axis and the second axis as two sides thereof.

4. A method according to claim 1, wherein the first image pair and any of the two key frames in the second image pair do not have any key frames in use, and the interpolation utilizes positional relations based on a quadrilateral having the first axis and the second axis as two sides opposite to each other.

5. A method according to claim 4, wherein a point Pc which represents the intermediate frame within the quadrilateral is such that the point Pc divides at a ratio of (1−t):t a line segment between a point Q, which divides a side of the quadrilateral connecting two points corresponding to the two key frames of the first image pair at a ratio of s:(1−s), and a point R, which divides a side of the quadrilateral connecting two points corresponding to the two key frames of the second image pair, where s and t are real numbers between 0 and 1.

6. A method according to claim 1, further comprising:
acquiring a positional relation between the intermediate frame, the two key frames of the first image pair and the two key frames of the second image pair,
wherein the interpolation is performed based on said positional relation.

7. A method according to claim 1, wherein the two key frames of the first image pair and the two key frames of the second image pair are images photographed respectively from a same view point but at different times.

8. A method according to claim 1, wherein the two key frames of the first image pair and the two key frames of the second image pair are images photographed respectively from different viewpoints.

9. An image interpolation method, comprising:
computing a matching between a first image pair comprised of two key frames, and detecting first corresponding point data between the two key frames of the first image pair;
computing a matching between a second image pair comprised of two key frames, and detecting second corresponding point data between the two key frames of the second image pair; and
generating an intermediate frame by interpolation, by utilizing positional relations of a first axis and a second axis, the first corresponding point data and the second corresponding point data,
wherein the first axis is determined temporally or spatially between the two key frames of the first image pair, and
the second axis is determined temporally or spatially between the two key frames of the second image pair.

10. A method according to claim 9, wherein said matching is computed pixel by pixel between the two key frames.

11. A method according to claim 10, wherein said matching is computed pixel by pixel based on correspondence between critical points detected through respective two-dimensional searches on the two key frames.

12. A method according to claim 11, wherein said computing and detecting includes:
multiresolutionalizing the two key frames by respectively extracting the critical points;
performing a pixel-by-pixel matching computation on the two key frames, at same resolution levels; and
acquiring a pixel-by-pixel correspondence relation at a finest level of resolution while inheriting a result of a pixel-by-pixel matching computation in a different resolution level.

13. An image interpolation apparatus, comprising:
a unit which stores a plurality of key frames;
a unit which acquires temporal or spatial position data on an intermediate frame, in relation to the key frames; and
an intermediate frame generator which generates an intermediate frame by an interpolation processing, based on corresponding point data for a first image pair comprised of two key frames and a second image pair comprised of two key frames, and the position data,
wherein the first image pair and the second image pair are determined so that a first axis determined temporally or spatially between the two key frames of the first image pair and a second axis determined temporally or spatially between the two key frames of the second image pair do not lie on a same line.

14. An apparatus according to claim 13, wherein said intermediate frame generator generates an image A corresponding to a point Q which lies on a line segment connecting two points that correspond to the two key frames of the first image pair, by the interpolation processing at a ratio of s:(1−s), and then generates an image B corresponding to a point R which lies on a line segment connecting two points that correspond to the two key frames of the second image pair, by the interpolation processing at a ratio of s:(1−s), and then generates an intermediate frame by performing the interpolation processing on the image A and image B at a ratio of (1−t):t, where s and t are real numbers between 0 and 1.

15. An apparatus according to claim 13, further comprising a matching processor which generates the corresponding point data.

16. An apparatus according to claim 13, wherein the two key frames of the first image pair and the two key frames of the second image pair are images photographed respectively from a same viewpoint but at different times.

17. An apparatus according to claim 13, wherein the two key frames of the first image pair and the two key frames of the second image pair are images photographed respectively from different viewpoints.

18. An apparatus according to claim 13, further comprising a user interface by which to input externally a specification regarding a temporal or spatial position of the intermediate frame to be generated.

19. A method according to claim 1, further comprising a user interface by which to input externally a specification regarding a temporal or spatial position of an intermediate frame to be generated.

20. A computer program executable by a computer, the program comprising the functions of:
acquiring a first image pair, comprising two key frames, and first corresponding point data between the two key frames of the first image pair;
acquiring a second image pair, comprising two key frames, and second corresponding point data between the two key frames of the second image pair; and
generating an intermediate frame by interpolation, wherein the interpolation utilizes positional relations of a first axis determined temporally or spatially between the two key frames of the first image pair and a second axis determined temporally or spatially between the two key frames of the second image pair, the first corresponding point data and the second corresponding point data.
